(19) United States
(12) Patent Application Publication
(10) Pub. No.: US 2012/0164503 A1
(43) Pub. Date: Jun. 28, 2012

(54) FLAT NONAQUEOUS SECONDARY BATTERY

(76) Inventor: Toshiki Ishikawa, Osaka (JP)

(21) Appl. No.: 13/394,258

(22) PCT Filed: Jul. 22, 2011
(86) PCT No.: PCT/JP2011/004146

§ 371 Date: Mar. 5, 2012

(30) Foreign Application Priority Data
Jul. 30, 2010 (JP) 2010-171645

(51) Int. Cl. H01M 10/02; H01M 4/02

(52) U.S. Cl. 429/94

(57) ABSTRACT

A flat nonaqueous secondary battery including: a positive electrode plate including a positive electrode active material; a negative electrode plate including a negative electrode active material; and a porous insulator arranged between the positive electrode plate and the negative electrode plate, wherein an electrode stack including the positive electrode plate and the negative electrode plate stacked with the porous insulator interposed therebetween is wound three or more times to form an electrode group which is flat when viewed in cross section, the electrode group includes a flat straight part, and a pair of curved parts, the electrode group is fixed with a fixing member not to become loosened, at least two gaps are provided between adjacent turns of the electrode stack in each of the curved parts, and one of the at least two gaps adjacent to each other inside the other gap is larger than the other gap.

### TECHNICAL FIELD

The present invention relates to a flat nonaqueous secondary battery using an electrode group for the flat nonaqueous secondary battery.

### BACKGROUND ART

In lithium secondary batteries which have widely been used as power sources of portable electronic devices, a carbon material capable of inserting and extracting lithium is used as a negative electrode active material, and composite oxide of transition metal and lithium, such as LiCoO₂ etc., is used as a positive electrode active material. Although the existing secondary batteries have high potential and high discharge capacity, higher capacity secondary batteries have been required to keep up with increasing functions of recent electronic devices and communication devices. In the electronic devices and communication devices, batteries are generally contained in rectangular (rectangular parallelepiped) space. Thus, flat nonaqueous secondary batteries containing battery components in a battery case are generally used.

To achieve the high capacity secondary battery, each of the positive and negative electrode plates is formed by applying a mixture of various materials to a collector, drying the mixture, and pressing the collector and the mixture to a predetermined thickness. In this case, a larger amount of the active material can be contained, and a density of the active material can be increased by the pressing, thereby increasing the capacity.

However, when the density of the active material in the electrode plate is increased, the electrode plate tends to expand in charge/discharge. This increases a thickness of an electrode group, and the thickness of the electrode group may exceed an upper limit of a predetermined thickness.

According to a proposed method, the positive electrode plate, the negative electrode plate, and a porous insulator interposed therebetween are wound to form an electrode group with strip-shaped spacers inserted in a curved part of the electrode group, and then the spacers are removed after the electrode group is formed to provide gaps between turns in the curved part of the electrode group. The gaps in the curved part can absorb the expansion of the electrode plates (see e.g., Patent Document 1).

According to another proposed method, an amount of expansion of the electrode group in charge/discharge is measured, and dimensions of a flat part and curved parts of the electrode group are determined based on the amount of expansion so that the amount of expansion can be absorbed (see e.g., Patent Document 2).

According to still another proposed method, the electrode group is formed by winding the positive and negative electrode plates with the porous insulator interposed therebetween. Then, hollow space in the electrode group is widened in a direction away from an axis of the electrode group, and the electrode group is externally pressed into a flat shape. This can reduce returning of the electrode group to the original shape (see e.g., Patent Document 3).

### CITATION LIST

### Patent Documents

[Patent Document 1] Japanese Patent Publication No. 2006-107742

[Patent Document 2] Japanese Patent Publication No. 2007-157560

[Patent Document 3] Japanese Patent Publication No. 2006-278184

### SUMMARY OF THE INVENTION

### Technical Problem

According to the method of Patent Document 1, an outermost turn of the electrode group is partially fixed with a tape. Thus, the expansion of the electrode plates always accumulates toward a first turn in charge/discharge, and the expansion cannot be completely absorbed. To prevent such a problem, gaps larger than the amount of expansion of the electrode plates can be provided between the turns. In this case, however, electrochemical reaction cannot occur sufficiently in the curved part in charge/discharge, and the battery capacity may decrease. In addition, the electrode plates may become misaligned in an axial direction of the electrode group in transferring the electrode group because the turns are loosely wound. This may bring the positive and negative electrode plates into contact, and may cause a short circuit.

According to the method of Patent Document 2, various types of electrode plates and porous insulators having different physical properties need to be studied in advance to measure the amount of expansion. This increases time for research and development, and requires severe control of machining values, such as thickness, tension, etc., and production conditions of the electrode plates and the porous insulator, thereby increasing production costs.

According to the method of Patent Document 3, a jig is inserted in the hollow space in the electrode group to widen the space. However, battery components such as the electrode plates and the porous insulator may break when a coefficient of friction between the jig and the components is high.

In view of the foregoing, the present invention has been achieved. The present invention is concerned with handling the expansion of the electrode plates in charge/discharge to provide a flat nonaqueous secondary battery in which increase in battery thickness is reduced.

### Solution to the Problem

In view of the above concern, a flat nonaqueous secondary battery of the present invention includes: a positive electrode plate including a positive electrode active material; a negative electrode plate including a negative electrode active material; and a porous insulator arranged between the positive electrode plate and the negative electrode plate, wherein an electrode stack including the positive electrode plate and the negative electrode plate stacked with the porous insulator interposed therebetween is wound three or more times to form an electrode group which is flat when viewed in cross section, the electrode group includes a flat straight part, and a pair of curved parts, the electrode group is fixed with a fixing member not to become loosened, at least two gaps are provided between adjacent turns of the electrode stack in each of the curved parts, and one of the at least two gaps adjacent to each other inside the other gap is larger than the other gap. The description “the electrode group is fixed with a fixing member not to become loosened” designates that an end of an outermost turn of the electrode stack constituting the electrode group is fixed to the electrode group with the fixing member. The “gap” designates an interval between the turns of the electrode stack adjacent to each other. One or more turns between the gaps adjacent to each other may be in close contact.

One of the gaps closest to an innermost turn may be the largest gap.

The gaps may include three or more gaps, and the gaps except for the one of the gaps closest to the innermost turn may have substantially the same size.

The gaps may include three or more gaps, and the gaps may increase in size with decreasing distance from the innermost turn.

The fixing member may be a battery case in which the electrode group and a nonaqueous electrolytic solution are sealed.

The fixing member may be an adhesive tape.

The cross section of the electrode group may be vertically or bilaterally asymmetric.

### Advantages of the Invention

According to the present invention, the gaps are provided between the turns of the electrode stack in each of the curved parts of the electrode group, and one of the gaps adjacent to each other inside the other gap is larger than the other gap. The gaps can absorb the expansion of the electrode plate in charge/discharge, and the larger inside gap can absorb the expansion of the electrode plate which accumulates inwardly in a circumferential direction of the electrode group, thereby reducing the expansion of the electrode group. This can reduce the increase in thickness of the flat nonaqueous secondary battery.

### BRIEF DESCRIPTION OF THE DRAWINGS

FIG. 1(a) is a cross-sectional view illustrating an electrode group of a flat nonaqueous secondary battery according to an embodiment, and FIG. 1(b) is an enlarged cross-sectional view of an electrode stack.

FIG. 2 is a cross-sectional view partially illustrating a curved part of the electrode group.

FIG. 3 is a perspective view of the flat nonaqueous secondary battery of the embodiment, partially cut away.

FIG. 4(a) shows how the electrode group of the embodiment is wound, FIG. 4(b) shows how the curved part is wound, FIG. 4(c) shows how the electrode stack is fed, and FIG. 4(d) shows how a straight part is wound.

FIG. 5(a) is a cross-sectional view illustrating an electrode group studied in advance, and FIG. 5(b) is a cross-sectional view partially illustrating a curved part of the electrode group.

FIG. 6 shows how another electrode group studied in advance is fabricated.

### DESCRIPTION OF EMBODIMENTS

Before description of embodiments, studies conducted by the inventor of the present invention will be described below.

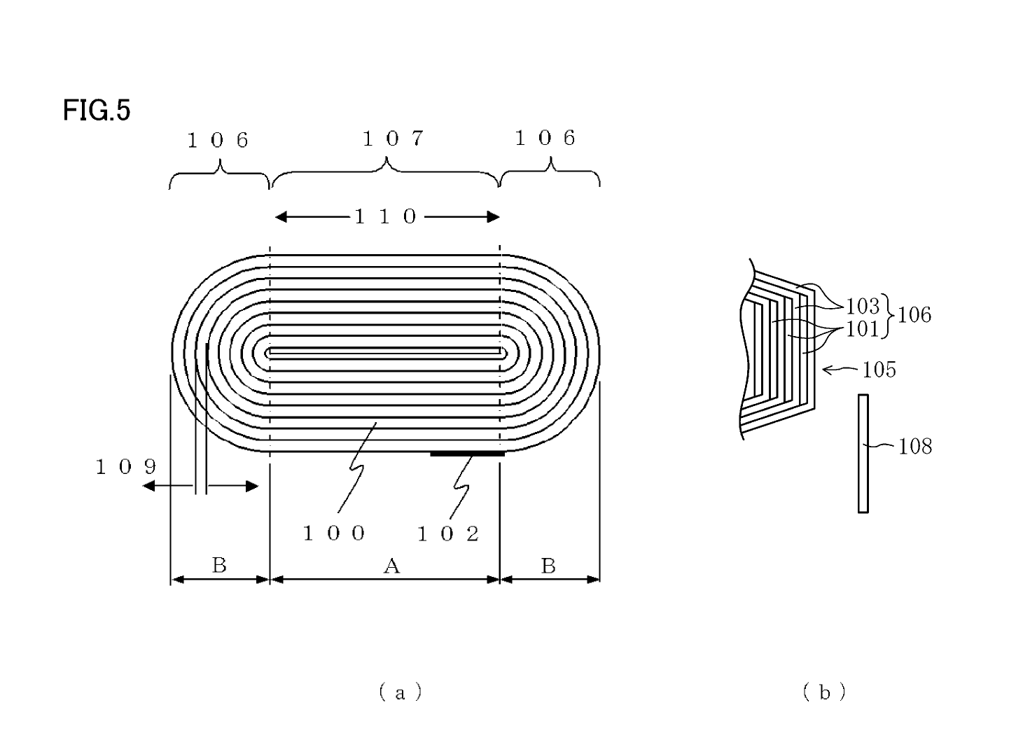

FIG. 5 shows an electrode group studied by the inventor of the present invention. To reduce expansion 109 and expansion 110 of the electrode group 100 in charge/discharge shown in FIG. 5(a), an amount of expansion of the electrode plates was measured in advance, and gaps 101 having the size corresponding to the amount of expansion were formed by inserting spacers 108 between turns of the electrode group as shown in FIG. 5(b). An outermost turn of the electrode group 100 was partially fixed with a tape 102 as shown in FIG. 5(a). Thus, when the electrode plates expanded in charge/discharge, the expansion 109 and the expansion 110 of the electrode plates were not able to propagate toward the outermost turn, but always accumulated toward an innermost turn. Therefore, the total amount of expansion was not easily absorbed. FIG. 5(b) shows the spacer 108 removed from the electrode group 100.

As a result, as shown in FIG. 5(b), when the gaps 101 larger than the amount of expansion of the electrode plate 103 were formed between the turns from the outermost turn to the innermost turn, electrochemical reaction did not occur sufficiently in the curved part 106 in charge/discharge, and capacity of the battery was reduced. In addition, the turns of the electrode plate 103 become misaligned in an axial direction in transferring the electrode group 100 because the turns are loosely wound. This brought the positive and negative electrode plates into contact, and caused a short circuit.

In fabricating the electrode group, the curved part 106 of the electrode group 100 was formed with the spacers 108 inserted between the turns of the electrode plate 103 of the electrode group 100 to form the gaps 101 as shown in FIGS. 5(a) and 5(b). When the curved part 106 was viewed microscopically, the electrode plate 103 imitated the shape of the spacer 108. Specifically, the electrode plate 103 was provided with an approximately trapezoidal part 105 having two angular vertices. The gaps formed by the spacers 108 absorbed the expansion 109 of the electrode plate 103 in the curved part 106 of the electrode group 100. However, since the electrode plate 103 in the curved part 106 was thickened, and the two angular vertices of the trapezoidal part 105 were brought into contact with the adjacent turn of the electrode plate 103 with high pressure, the turns of a straight part 107 were not able to slide in the major axis direction of the electrode plate 103. Thus, the expansion 110 of the straight part 107 in the major axis direction was not absorbed by the gaps 101. Eventually, the electrode plate 103 constituting the straight part 107 was warped from the angular vertices of the trapezoidal part 105, and the turns became partially loose and partially tight. A large current flowed through the tight part to generate heat, thereby breaking the porous insulator, and causing an internal short circuit.

Then, the inventor tried to measure the amount of expansion of the electrode group in charge/discharge in such a manner that dimensions of the straight part and the curved part can be determined to absorb the amount of expansion. In this case, however, various types of electrode plates and porous insulators having different physical properties need to be studied in advance to measure the amount of expansion. This increases time for research and development, and requires severe control of machining values, such as thickness, tension, etc., and production conditions of the electrode plates and the porous insulator, thereby increasing production costs.

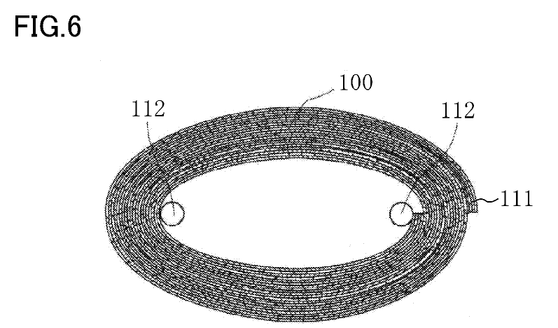

The inventor studied another example in which hollow space in the wound electrode group was widened in a direction away from an axis of the electrode group, and the electrode group was externally pressed into a flat shape to prevent the electrode group from returning to the original shape. However, a jig 112 inserted in the hollow space to widen the hollow space of the electrode group 100 as shown in FIG. 6 broke a component 111, such as the electrode plate, the porous insulator, etc., when a coefficient of friction between the jig 112 and the component 111 was high.

The present invention has been achieved based on the above studies. Embodiments of the invention will be described below.

### First Embodiment

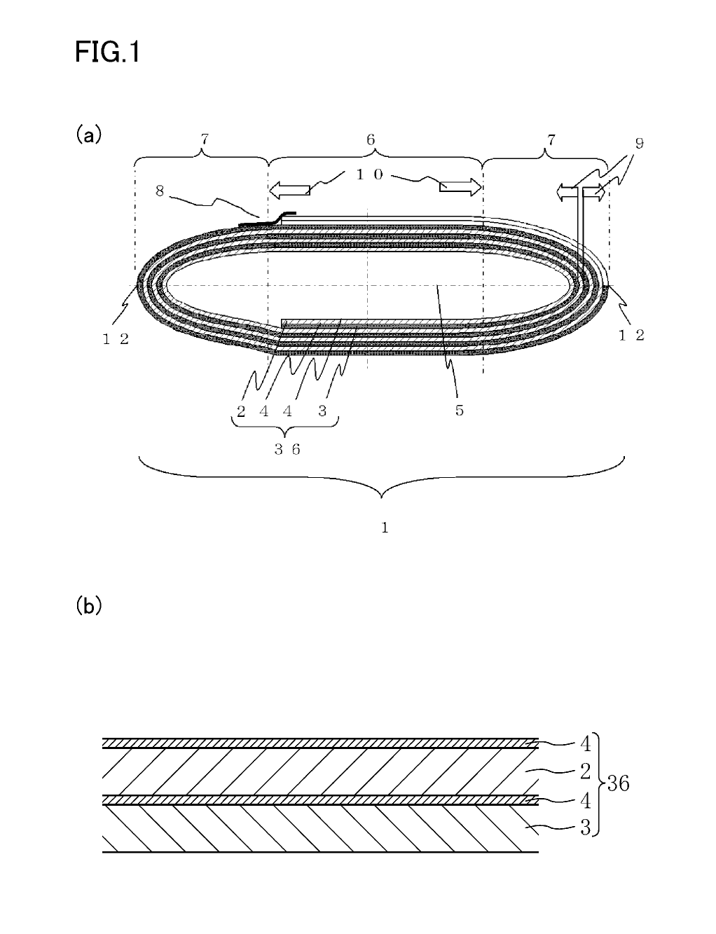

FIGS. 1(a) and 1(b) show an electrode group 1 formed by winding an electrode stack 36 including a negative electrode plate 2, a positive electrode plate 3, and a porous insulator 4 three or more times. The electrode group 1 has a major axis 5, a straight part 6 which is flat and parallel to the major axis 5, and a pair of curved parts 7, each of which includes vertices 12 of turns of the wound electrode stack located on the major axis 5, and is bent to connect a terminal end of the straight part 6 and the vertices 12. The electrode group 1 is fixed with an end tape 8 (a fixing member, an adhesive tape) which prevents loosening of the electrode plates. Arrows indicate expansion 10 of the straight part 6 and expansion 9 of the curved part 7 of the electrode plates in charge/discharge.

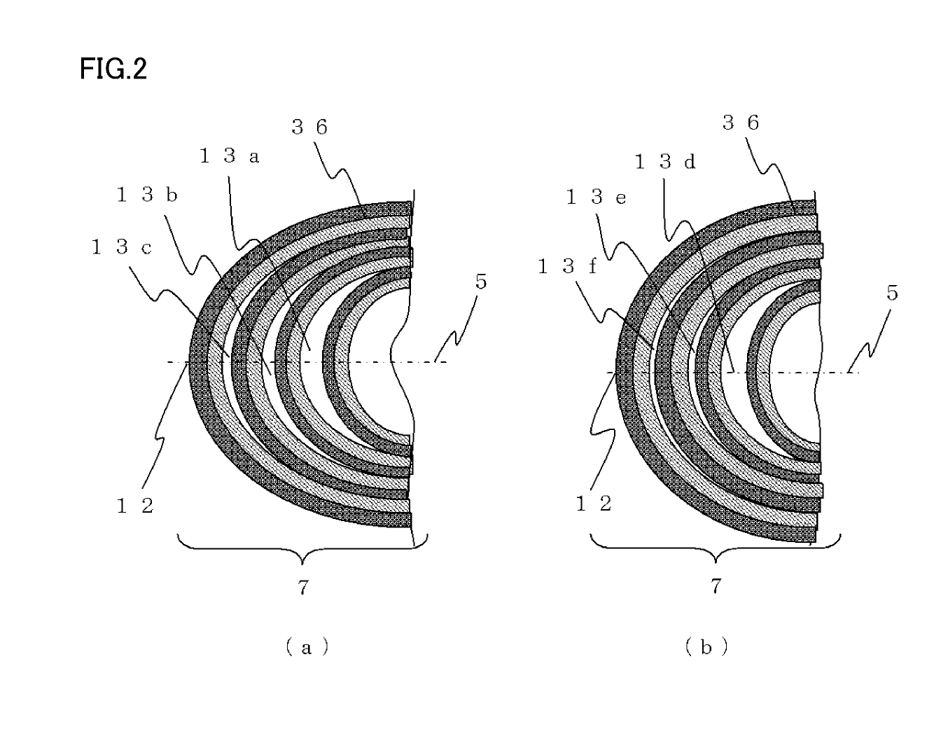

FIG. 2(a) is a cross-sectional view partially illustrating the curved part 7 of the electrode group 1. The curved part 7 includes the vertices 12 of the turns located on the major axis 5, and is bent to connect the vertices 12 and the terminal end of the straight part 6. Gaps 13a-13c, each of which is formed between the electrode plate and the porous insulator 4, are provided in the curved part 7.

In the present embodiment, the gaps 13a-13c have different sizes as shown in FIG. 2(a), i.e., the gaps 13a13b, and 13c increase in size with decreasing distance from the innermost turn.

In charging/discharging the electrode group 1 shown in FIGS. 1(a) and 1(b), lithium ions are inserted in the negative electrode plate 2, and the negative electrode plate 2 expands in a thickness direction, thereby causing the expansion 9 and the expansion 10. According to the studies and findings of the inventor, the expansion 9 of the curved part 7 in which the turns of the electrode stack 36 are in close contact cannot propagate outwardly in a circumferential direction of the electrode group 1 because an outermost turn of the electrode stack 36 is fixed with the end tape 8, and propagates inwardly toward the looser innermost turn. Eventually, the expansion 9 propagates to the straight part 6, and the straight part 6 of the electrode stack 36 is warped to absorb the expansion 9. Due to the warpage of the electrode stack 36, the turns of the electrode group 1 become partially loose and partially tight.

When the electrode group 1 in which the electrode stack 36 is corrugated to make the turns partially loose and partially tight is charged/discharged, electrochemical reaction does not sufficiently occur in the loose part, and battery properties may become poor. In the tight part, the electrode plate tends to expand locally, and a large current flows to generate heat. This may break the porous insulator 4, and cause an internal short circuit.

Specifically, the electrode stack 36 in the curved part 7 causes the expansion 9 in charge/discharge. Since the electrode stack is fixed with the end tape 8, the expansion 9 cannot propagate outwardly in the circumferential direction, and accumulates toward the innermost turn. Thus, the gap 13a closer to the innermost turn needs to be a larger gap which can absorb a larger amount of expansion. The inventor has found that the expansion of the electrode plate can be absorbed by the gap, thereby reducing the warpage of the electrode plate in the straight part 6, and reducing increase in thickness of the battery.

In view of the results of the studies, the gaps 13a-13c which increase in size with decreasing distance from the innermost turn are provided between the turns in the curved part 7 of the electrode group 1 of the present invention as shown in FIG. 2(a).

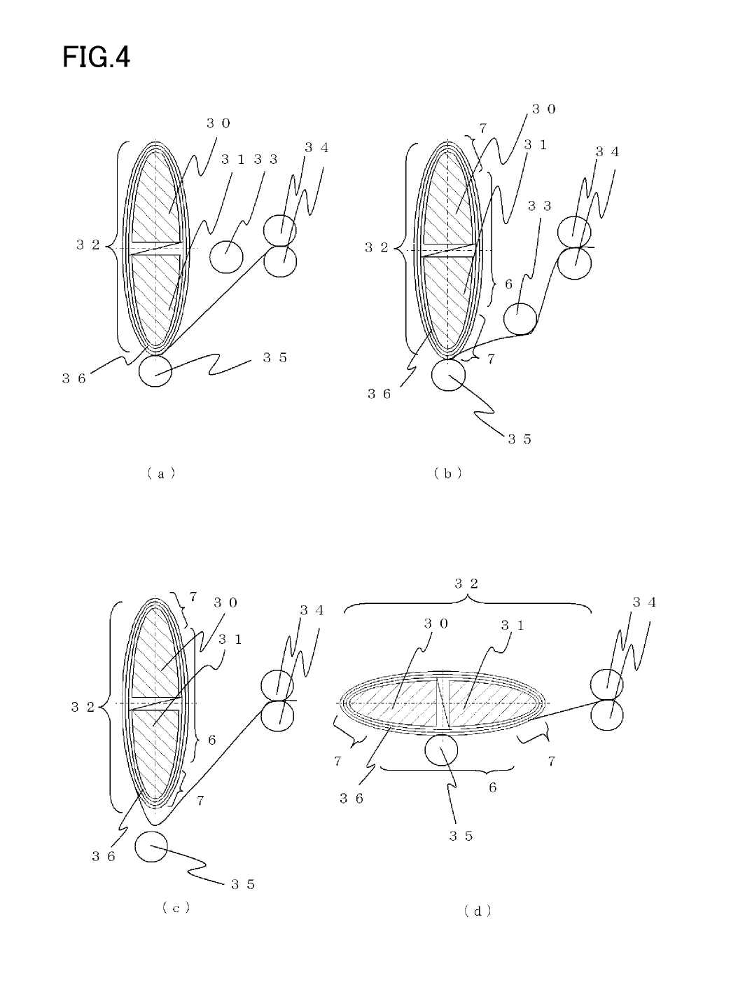

FIGS. 4(a)-4(d) show how to fabricate the electrode group 1. Specifically, FIG. 4(a) shows how the electrode stack 36 is wound around a core 32. FIG. 4(b) shows how the electrode stack 36 is fed to the core 32 in winding the electrode stack 36 on a curved part 7 of the core 32. FIG. 4(c) shows the electrode stack 36 immediately after being fed to the core. FIG. 4(d) shows how the electrode stack 36 is wound on a straight part 6 of the core 32.

As shown in FIG. 4(a), the electrode stack 36 including the negative electrode plate 2, the positive electrode plate 3, and the porous insulator 4 is sandwiched between an upper core 30 and a lower core 31, and the core 32 is rotated clockwise predetermined times to wind the electrode stack 36. Specifically, as shown in FIG. 4(b), the electrode stack 36 is pushed downward by a pushing roller 33 before winding the electrode stack 36 on the curved part 7 to draw a predetermined length of the electrode stack 36. At this time, nip rollers 34 are closed, and a pressing roller 35 presses the electrode stack 36. Then, as shown in FIG. 4(c), the pushing roller 33 is returned to an initial position, and the pressing roller 35 is moved downward to feed the electrode stack 36 toward the core 32. Finally, as shown in FIG. 4(d), the electrode stack 36 is wound on the straight part 6 while pressing the straight part 6 with the pressing roller 35 to form the gap in the curved part 7 of the electrode group 1. Specifically, the pressing roller 35 and the pushing roller 33 adjust a winding tension, a draw length of the electrode stack 36, and a size of the gap.

The electrode group 1 is fabricated by repeating the steps of FIGS. 4(b)-4(d). Thus, the gaps 13a-13c can be formed between the turns in the curved part 7.

The above method is merely an example, and the electrode group 1 of the present invention can be fabricated by any method as long as the gaps 13a-13c are formed in the curved part 7 of the electrode group 1.

A flat nonaqueous secondary battery as a lithium secondary battery will be described in detail below.

The electrode plates of the electrode group 1 shown in FIGS. 1(a) and 1(b) will be described first. The positive electrode plate 3 is formed by mixing and dispersing a positive electrode active material, a conductive agent, and a binder in a dispersion medium using a disperser, such as a planetary mixer etc., to prepare a positive electrode mixture, applying the positive electrode mixture to one or both of surfaces of a positive electrode collector which is 5 μm-30 μm thick foil or nonwoven fabric made of aluminum or aluminum alloy, drying the mixture, and rolling the mixture and the collector.

Examples of the positive electrode active material may include lithium cobaltate and denatured lithium cobaltate (lithium cobaltate containing aluminum or magnesium in the state of solid solution), lithium nickelate and denatured lithium nickelate (lithium nickelate partially substituted with cobalt), and lithium manganate and denatured lithium manganate. Examples of the conductive agent may include carbon blacks such as acetylene black, Ketchen black, channel black, furnace black, lamp black, thermal black, etc., and various types of graphites used alone or in combination. Examples of the binder for the positive electrode plate may include polyvinylidene fluoride (PVdF), denatured polyvinylidene fluoride, polytetrafluoroethylene (PTFE), a rubber particle binder containing an acrylate unit, etc.

The negative electrode plate 2 is formed by mixing and dispersing a negative electrode active material, a binder, and if necessary, a conductive agent and a thickener, in a dispersion medium using a dispenser, such as a planetary mixer etc., to prepare a negative electrode mixture, applying the negative electrode mixture to one or both of surfaces of a 5 μm-25 μm thick negative electrode collector made of rolled copper foil, electrolytic copper foil, or nonwoven copper fiber fabric, drying the mixture, and rolling the mixture and the collector.

Examples of the negative electrode active material may include various types of natural and artificial graphites, silicon-based composite material such as silicide, and various alloys. Examples of the binder for the negative electrode plate may include various types of binders such as PVdF and denatured PVdF. For easy insertion of lithium ions, particles of styrene-butadiene rubber (SBR) and denatured SBR are used. Examples of the thickener may include materials having viscosity in the state of an aqueous solution, such as polyethylene oxide (PEO), polyvinyl alcohol (PVA), etc. Cellulosic resins such as carboxymethyl cellulose (CMC) and denatured cellulosic resins are preferable for good dispersibility and viscosity of the mixture.

In a nonaqueous electrolytic solution, various types of lithium compounds, such as LiPF₆ and LiBF₄, may be used as electrolyte salt. Ethylene carbonate (EC), dimethyl carbonate (DMC), diethyl carbonate (DEC), and methyl ethyl carbonate (MEC) may be used alone or in combination as a solvent. Vinylene carbonate (VC), cychlohexylbenzene (CHB), and denatured VC and CHB may preferably used to form a good coating on the positive and negative electrode plates, or to ensure stability when the battery is overcharged.

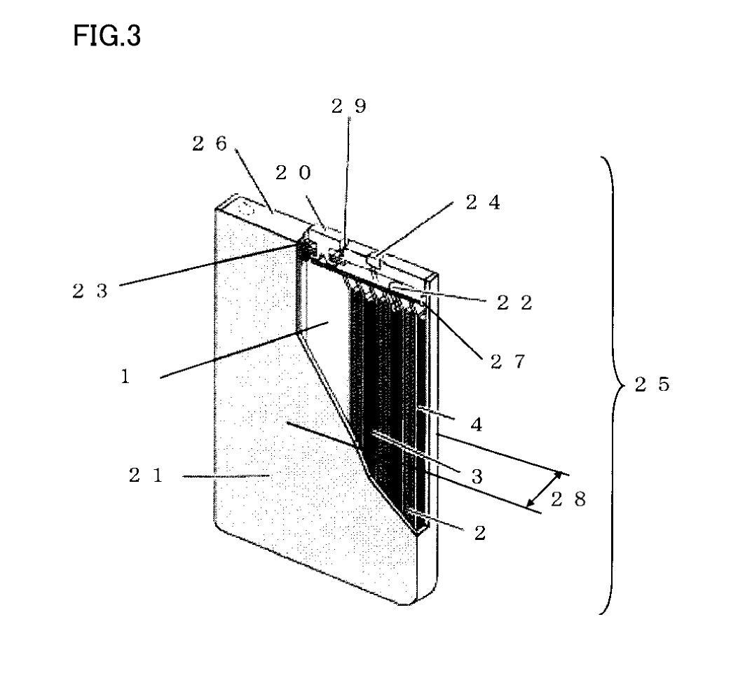

FIG. 3 is a perspective view of a flat nonaqueous secondary battery 25. The electrode group 1 and an insulating frame 27 are contained in a flat battery case 21 having a closed bottom. A negative electrode lead 23 and a positive electrode lead 22 are provided above the electrode group 1. The negative electrode lead 23 is connected to a terminal 20 around which an insulating gasket 29 is attached, and the positive electrode lead 22 is connected to a sealing plate 26. The sealing plate 26 includes a plug 24. Reference character 28 shown in the middle of the battery case 21 designates a thickness of the battery. Specifically, the electrode group 1 shown in FIG. 1 is pressed in a direction of the thickness of the electrode group 1 to make the electrode group flat, and the flat electrode group 1 and the insulating frame 27 are placed in the flat battery case 21 having the closed bottom. Then, the negative electrode lead 23 drawn from an upper end of the electrode group 1 is connected to the terminal 20, and the positive electrode lead 22 drawn from the upper end of the electrode group 1 is connected to the sealing plate 26. Then, the sealing plate 26 is inserted in an opening of the battery case 21, and the sealing plate 26 is welded to an opening end of the battery case 21 to seal the battery case 21. A predetermined amount of a nonaqueous electrolytic solution (not shown) made of a nonaqueous solvent is injected in the battery case 21 through a plug port, and the plug 24 is welded to the sealing plate 26. Thus, the flat nonaqueous secondary battery 25 is fabricated.

The above method is merely an example, and the method of the present invention is not limited thereto.

### Second Embodiment

A second embodiment is the same as the first embodiment except for the size of the gaps between the turns of the wound electrode stack 36. Thus, the difference between the second and first embodiments will be described below.

In the curved part 7 of the electrode group 1 of the present embodiment, as shown in FIG. 2(b), a gap 13d closest to an innermost turn is the largest gap, and the other gaps 13e and 13f are smaller than the gap 13d, and have the same size.

The second embodiment can provide the same advantages as those of the first embodiment.

The present invention will be described in further detail by way of examples.

### EXAMPLE 1

In Example 1, gaps 13a, 13b, and 13c which increased in size with decreasing distance from an innermost turn were formed in a curved part 7 of an electrode group 1 as shown in FIG. 2(a).

Then, a flat nonaqueous secondary battery 25 which was 6 mm in battery thickness 28 shown in FIG. 3, 35 mm in width, and 35 mm in height was fabricated.

Electrode plates were formed in the following manner. First, 100 parts by weight (pbw) of lithium cobaltate as a positive electrode active material, 2 pbw of acetylene black as a conductive agent relative to 100 pbw of the active material, 2 pbw of polyvinylidene fluoride as a binder relative to 100 pbw of the active material, and an appropriate amount of N-methyl-2-pyrrolidone were stirred and kneaded in a dual arm kneader to prepare a positive electrode mixture.

The positive electrode mixture was applied to each surface of a positive electrode collector made of 15 μm thick aluminum foil, and dried to obtain a positive electrode plate 3 having a 100 μm thick positive electrode mixture layer on each surface. The positive electrode plate 3 was pressed to a total thickness of 165 μm to reduce the thickness of each of the positive electrode mixture layers on the positive electrode collector made of aluminum foil to 75 μm, and the obtained product was cut into a predetermined width of the electrode group 1 for the flat nonaqueous secondary battery 25 shown in FIG. 1. In this way, the positive electrode plate 3 was fabricated.

Then, 100 pbw of artificial graphite as a negative electrode active material, 2.5 pbw of a dispersion of styrene-butadiene rubber particles (solid content: 40 weight percent (wt. %)) as a binder (1 pbw in terms of a solid content of the binder) relative to 100 pbw of the active material, 1 pbw of carboxymethyl cellulose as a thickener relative to 100 pbw of the active material, and an appropriate amount of water were stirred in a dual arm kneader to prepare a negative electrode mixture. Then, the negative electrode mixture was applied to each surface of a negative electrode collector made of 10 μm thick copper foil, and dried to form a negative electrode plate 2 having a 100 μm thick negative electrode mixture layer on each surface. The negative electrode plate 2 was pressed to a total thickness of 170 μm to reduce the thickness of each of the negative electrode mixture layers to 80 μm, and the obtained product was cut into a predetermined width of the electrode group 1 for the flat nonaqueous secondary battery 25 shown in FIG. 3. In this way, the negative electrode plate 2 was fabricated.

A method for fabricating the electrode group 1 will be described below.

As shown in FIG. 4(a), an electrode stack 36 including the negative electrode plate 2, the positive electrode plate 3, and a porous insulator 4 was sandwiched between an upper core 30 and a lower core 31, and a core 32 was rotated clockwise to wind the electrode stack 36.

Specifically, as shown in FIG. 4(b), the electrode stack 36 was pushed downward by a pushing roller 33 before winding the electrode stack 36 on a curved part 7 of the core 32 to draw a predetermined length of the electrode stack 36. More specifically, before winding a turn of the electrode group 1 on the curved part 7 of the core 32, the roller 33 was moved downward to increase a draw length of the electrode stack 36. The distance in which the roller 33 moved downward was gradually reduced after every turn to gradually reduce the draw length of the electrode stack 36. In this way, as shown in FIG. 2(a), the gaps 13a, 13b, and 13c which increased in size with decreasing distance from the innermost turn were formed.

Then, as shown in FIG. 4(c), the pushing roller 33 was returned to an initial position, and a pressing roller 35 was moved downward to feed the electrode stack 36 to the core 32. Finally, as shown in FIG. 4(d), the electrode stack 36 was wound on a straight part 6 of the core 32 with the pressing roller 35 pressing the straight part 6 to provide the gaps 13a-13c in the curved part 7 of the electrode group 1. The steps of FIGS. 4(b)-4(d) were repeated to fabricate the electrode group 1 unpressed. An end tape 8 was adhered to an outermost turn of the electrode stack 36. The obtained electrode group 1 was then pressed into a flat shape.

### EXAMPLE 2

In Example 2, a gap 13d closest to an innermost turn as the largest gap, and gaps 13e , 13f other than the gap 13d having a uniform size were formed in a curved part 7 of an electrode group 1 as shown in FIG. 2(b).

Then, a flat nonaqueous secondary battery 25 which was 6 mm in battery thickness 28 shown in FIG. 3, 35 mm in width, and 35 mm in height was fabricated.

Electrode plates were fabricated in the same manner as Example 1. First, 100 pbw of lithium cobaltate as a positive electrode active material, 2 pbw of acetylene black as a conductive agent relative to 100 pbw of the active material, 2 pbw of polyvinylidene fluoride as a binder relative to 100 pbw of the active material, and an appropriate amount of N-methyl-2-pyrrolidone were stirred and kneaded in a dual arm kneader to prepare a positive electrode mixture.

The positive electrode mixture was applied to each surface of a positive electrode collector made of 15 μm thick aluminum foil, and dried to obtain a positive electrode plate 3 having a 100 μm thick positive electrode mixture layer on each surface. The positive electrode plate 3 was pressed to a total thickness of 165 μm to reduce the thickness of each of the positive electrode material layers on the positive electrode collector made of aluminum foil to 75 μm, and the obtained product was cut into a predetermined width of the electrode group 1 for the flat nonaqueous secondary battery 25 shown in FIG. 3. In this way, the positive electrode plate 3 was fabricated.

Then, 100 pbw of artificial graphite as a negative electrode active material, 2.5 pbw of a dispersion of styrene-butadiene rubber particles (solid content: 40 wt. %) as a binder (1 pbw in terms of a solid content of the binder) relative to 100 pbw of the active material, 1 pbw of carboxymethyl cellulose as a thickener relative to 100 pbw of the active material, and an appropriate amount of water were stirred in a dual arm kneader to prepare a negative electrode mixture. Then, the negative electrode mixture was applied to each surface of a negative electrode collector made of 10 μm thick copper foil, and dried to form a negative electrode plate 2 having a 100 μm thick negative electrode mixture layer on each surface. The negative electrode plate 2 was pressed to a total thickness of 170 μm to reduce the thickness of each of the negative electrode mixture layers to 80 μm, and the obtained product was cut into a predetermined width of the electrode group 1 for the flat nonaqueous secondary battery 25 shown in FIG. 3. In this way, the negative electrode plate 2 was fabricated.

A method for fabricating the electrode group 1 will be described below.

As shown in FIG. 4(a), an electrode stack 36 including the negative electrode plate 2, the positive electrode plate 3, and a porous insulator 4 was sandwiched between an upper core 30 and a lower core 31, and a core 32 was rotated clockwise to wind the electrode stack 36.

Specifically, as shown in FIG. 4(b), the electrode stack 36 was pushed downward by a pushing roller 33 before winding the electrode stack 36 on a curved part 7 of the core 32 to draw a predetermined length of the electrode stack 36. More specifically, before winding a turn of the electrode group 1 on the curved part 7, the roller 33 was moved downward to increase a draw length of the electrode stack 36. After the first turn was wound, the distance in which the roller 33 moved downward was reduced, and the electrode stack 36 was wound with the distance kept reduced. In this way, as shown in FIG. 2(b), the gap 13d closest to the innermost turn was formed as the largest gap, and the other gaps 13e , 13f having the same size were formed.

Then, as shown in FIG. 4(c), the pushing roller 33 was returned to an initial position, and a pressing roller 35 was moved downward to feed the electrode stack 36 to the core 32.

Finally, as shown in FIG. 4(d), the electrode stack 36 was wound on a straight part 6 of the core 32 with the pressing roller 35 pressing the straight part 6 to provide the gaps 13d-13f in the curved part 7 of the electrode group 1. The steps of FIGS. 4(b)-4(d) were repeated to fabricate the electrode group 1 unpressed. An end tape 8 was adhered to an outermost turn of the electrode stack 36. The obtained electrode group 1 was then pressed into a flat shape.

### COMPARATIVE EXAMPLE 1

Comparative Example 1 was the same as Example 1 except that an electrode plate 103 was wound with spacers 108 of uniform thickness sandwiched between turns of the electrode plate 103 in a curved part 106 of an electrode group 100 shown in FIGS. 5(a) and 5(b), the wound product was flattened with the spacers 108 kept sandwiched between the turns, and then the spacers 108 were removed to provide an electrode group 100 having gaps 101 of equal size between the turns. Then, an end tape 102 was adhered to an outermost turn of the electrode plate.

Then, a flat nonaqueous secondary battery 25 which was 6 mm in battery thickness 28 shown in FIG. 3, 35 mm in width, and 35 mm in height was fabricated. Each of the electrode groups 1 of Example 1, Example 2, and Comparative Example 1 was placed in a battery case 21 having a closed bottom shown in FIG. 3 with an insulating frame 27. A negative electrode lead 23 drawn from an upper end of the electrode group 1 was connected to a terminal 20 around which an insulating gasket 29 was attached, and a positive electrode lead 22 drawn from the upper end of the electrode group 1 was connected to a sealing plate 26. The sealing plate 26 was inserted in an opening of the battery case 21, and the sealing plate 26 was welded to an opening end of the battery case 21 to seal the battery case 21. A predetermined amount of a nonaqueous electrolytic solution made of a nonaqueous solvent (not shown) was injected in the battery case 21 through a plug port, and then a plug 24 was welded to the sealing plate 26. Thus, the flat nonaqueous secondary battery 25 was fabricated.

The electrode groups 1 of Example 1, Example 2, and Comparative Example 1, 100 each, were fabricated, and 60 of which were used to fabricate the flat nonaqueous secondary batteries 25, and 40 of which were merely placed in the battery cases. The 100 electrode groups were evaluated as follows.

For evaluation of increase in thickness, the thickness of the flat nonaqueous secondary battery 25 was measured immediately after the fabrication, and after 500 charge/discharge cycles (500 cycles), and the measured thicknesses were compared.

Whether the electrode plate was warped or not was evaluated by visually checking images of a vertical cross section of a center of the flat nonaqueous secondary battery 25 taken by X-ray computerized axial tomography (hereinafter abbreviated as CT) immediately after the fabrication, and after the 500 cycles.

The battery was charged/discharged 500 times, and a ratio of discharge capacity after the 500^{th} cycle relative to discharge capacity after the first cycle was obtained as capacity retention rate after 500 cycles.

TABLE 1

| | | Warpage of negative | |
|---|---|---|---|
| | | electrode plate | |
| | | and positive | Capacity retention |
| | Battery thickness | electrode plate | rate (%) after |
| | after 500 cycles | after 500 cycles | 500 cycles |
| Example 1 | Slightly increased | Not warped | 89 |
| Example 2 | Slightly increased | Not warped | 88 |
| Comparative | Greatly increased | Warped | 73 |
| Example 2 | | | |

The results shown in Table 1 indicate that the increase in battery thickness after the 500 cycles was smaller in Examples 1 and 2 than in Comparative Example 1. The negative electrode plate 2 and the positive electrode plate 3 of Examples 1 and 2 were not warped, and the capacity retention rate was as good as 88%-89%.

Specifically, in Example 1, the electrode group was provided with the gaps 13a, 13b, and 13c gradually increased in size with decreasing distance from the innermost turn as shown in FIG. 2(a). Thus, the gaps 13a, 13b, and 13c of different sizes gradually absorbed the expansion 9 of the curved part 7 which gradually accumulated from the outer turn to the inner turn. Therefore, the expansion 9 did not propagate to the straight part 6, and the electrode stack 36 was not warped. This presumably reduced the increase in battery thickness.

The turns of the electrode stack in the curved part 7 relatively slid, and the expansion 10 of the straight part 6 was absorbed by the gaps 13a-13c. Thus, the expansion 10 of the straight part 6 smoothly propagated to the curved part 7, and the straight part 6 was not warped. Therefore, the increase in battery thickness after the 500 cycles was relatively small as compared with Comparative Example 1.

In Example 2, as shown in FIG. 2(b), the gap 13d closest to the innermost turn was the largest, and the other gaps 13e and 13f had the uniform size. When the curved part 7 caused the expansion 9, the expansion 9 of the outer turn was not absorbed by the gaps 13f and 13e , and accumulated toward the inner turn. Since the gap 13d closest to the innermost turn was larger than the gaps 13e and 13f, the expansion 9 was absorbed by the gap 13d. Thus, the expansion 9 did not propagate to the straight part 6, and the electrode stack 36 was not warped. This presumably reduced the increase in battery thickness. In addition, the turns of the electrode plate relatively slid, and the expansion 10 of the straight part 6 was absorbed by the gaps 13a-13c in the curved part 7. Thus, the expansion 10 of the straight part 6 smoothly propagated to the curved part 7, and the straight part 6 was not warped. This presumably reduced the increase in battery thickness after the 500 cycles as compared with Comparative Example 1.

Regarding the capacity retention rate after the 500 cycles, the electrode plate constituting the straight part 6 was not warped as described above, and nonuniform space was not formed between the turns of the electrode stack 36 in the straight part 6. It was presumed that the electrochemical reaction occurred normally because the turns of the electrode stack 36 were in close contact.

In Comparative Example 1, the increase in battery thickness after the 500 cycles was larger than that in Examples 1 and 2, and the capacity retention rate was as low as 73%. As shown in FIG. 5(b), in Comparative Example 1, the uniform gaps 101 were formed between the turns in the curved part 106, and the outermost turn was fixed. Thus, the expansion 109 did not propagate toward the outermost turn in the circumferential direction, but accumulated inwardly toward the innermost turn. Thus, the inner gap 101 needed to be larger. However, in this example, the gaps 101 between the turns were provided to merely absorb the amount of expansion of the electrode plate 103. Thus, the expansion 109 accumulated toward the innermost turn was not absorbed in the curved part 106, and propagated to the straight part 107 to warp the electrode plate 103. This presumably increased the battery thickness.

Although the inventor tried to provide the uniform gaps 101 larger than the above example in the electrode group 100, the electrode group was not fabricated because the positive and negative electrode plates were misaligned in the axial direction of the electrode group 100 in transferring the electrode group. Thus, the gaps larger than the above example was not provided.

In fabricating the electrode group, the spacers 108 were inserted between the turns in the curved part 106 shown in FIG. 5(b) to form the gaps 101. Thus, the electrode plate imitated the shape of the spacer 108, and the electrode plate was provided with an approximately trapezoidal part 105. Thus, when the straight part 107 caused the expansion 110, the turns of the electrode plate 103 were brought into contact with high pressure, and the turns were not able to relatively slide. The expansion 110 of the straight part 107 was not absorbed by the gaps 101, i.e., the expansion 110 did not propagate anywhere, and the electrode plate 103 constituting the straight part 107 was warped. This presumably increased the battery thickness.

Regarding the capacity retention rate after the 500 cycles, nonuniform space was formed between the turns of the electrode plate 103 constituting the straight part 6 because the electrode plate constituting the straight part 6 was warped as described above. Thus, the turns of the electrode stack 36 were not in close contact, and the electrochemical reaction did not occur sufficiently. This presumably reduced the capacity.

With the provision of the gaps 13a-13c and the gaps 13d-13f which increase in size with decreasing distance from the innermost turn of the electrode group 1, the expansion 10 and the expansion 9 of the straight part 6 and the curved part 7 in charge/discharge can be absorbed by the gaps 13a-13c and the gaps 13d-13f. This can reduce the warpage of the electrode plates and the increase in battery thickness in charge/discharge, and can alleviate decrease in battery capacity.

In the above-described embodiments and examples, there is no need to check the amount of expansion of various types of electrode plates and porous insulators having difficult physical properties in advance. In addition, there is no risk of breaking the electrode plates and the porous insulator in widening the hollow space in the electrode group, and there is no need to produce a jig for widening the hollow space. Thus, the electrode group for the flat nonaqueous secondary battery can be provided with high safety, and reduced production costs.

### Other Embodiments

The above-described embodiments have been set forth merely for the purposes of preferred examples in nature, and the present invention is not limited to the embodiments. The above-described embodiments and examples to which well-known and common technologies applied, or which are modified by those skilled in the art are still within the scope of the present invention. The battery case may be a laminated container. The laminated container is made of metal foil laminated with a resin film.

When the electrode group is placed in the battery case, the battery case can hold the electrode stack to function as the fixing member.

### INDUSTRIAL APPLICABILITY

According to the present invention, the flat nonaqueous secondary battery includes the electrode group which is formed by winding the positive electrode plate including the active material and the negative electrode plate including the active material with the porous insulator interposed therebetween, fixing an outermost turn of the wound product, and flattening the wound product, and is placed in the battery case with a nonaqueous electrolytic solution. The electrode group includes a straight part parallel to a major axis of a cross section of the electrode group, and a curved part which includes vertices of turns located on the major axis, and connects the vertices and a terminal end of the straight part. One of the gaps formed between the turns of the electrode group in the curved part, i.e., between the electrode plate and the porous insulator, closest to the innermost turn is larger than the other gaps. Thus, the gaps can absorb the expansion of the electrode plate in the straight part and the curved part in charge/discharge, thereby reducing the warpage of the electrode plate, reducing the increase in battery thickness, and alleviating the decrease in battery capacity. This can provide the flat nonaqueous secondary battery with high safety.

### DESCRIPTION OF REFERENCE CHARACTERS

1 Electrode group
2 Negative electrode plate
3 Positive electrode plate
4 Porous insulator
5 Major axis
6 Straight part
7 Curved part
8 End tape
9, 10 Expansion
12 Vertex
13a-13f Gap
20 Terminal
21 Battery case
22 Positive electrode lead
23 Negative electrode lead
24 Plug
25 Flat nonaqueous secondary battery
26 Sealing plate
27 Insulating frame
28 Battery thickness
29 Insulating gasket
30 Upper core
31 Lower core
32 Core
33 Pushing roller
34 Nip roller
35 Pressing roller
36 Electrode stack

1. (canceled)

2. A flat nonaqueous secondary battery comprising:
a positive electrode plate including a positive electrode active material;
a negative electrode plate including a negative electrode active material; and
a porous insulator arranged between the positive electrode plate and the negative electrode plate, wherein
an electrode stack including the positive electrode plate and the negative electrode plate stacked with the porous insulator interposed therebetween is wound three or more times to form an electrode group which is flat when viewed in cross section,
the electrode group includes a flat straight part, and a pair of curved parts,
the electrode group is fixed with a fixing member not to become loosened,
at least two gaps are provided between adjacent turns of the electrode stack in each of the curved parts,
one of the at least two gaps adjacent to each other inside the other gap is larger than the other gap, and
one of the at least two gaps closest to an innermost turn is the largest gap.

3. The flat nonaqueous secondary battery of claim 2, wherein
the gaps include three or more gaps, and the gaps except for the one of the gaps closest to the innermost turn have substantially the same size.

4. The flat nonaqueous secondary battery of claim 2, wherein
the gaps include three or more gaps, and the gaps increase in size with decreasing distance from the innermost turn.

5. The flat nonaqueous secondary battery of claim 2, wherein
the fixing member is a battery case in which the electrode group and a nonaqueous electrolytic solution are sealed.

6. The flat nonaqueous secondary battery of claim 2, wherein the fixing member is an adhesive tape.
